(19) United States
(12) Patent Application Publication
(10) Pub. No.: US 2004/0049448 A1
(43) Pub. Date: Mar. 11, 2004

(54) Method of defining an exchange-traded fund and computer product for generating real-time fund information

(76) Inventor: Bob Glickman, Hallandale, FL (US)

Correspondence Address: LERNER AND GREENBERG, P.A., POST OFFICE BOX 2480, HOLLYWOOD, FL, 33022-2480, US

(21) Appl. No.: 10/659,694

(22) Filed: Sep. 10, 2003

Related U.S. Application Data
(60) Provisional application No. 60/409,648, filed on Sep. 10, 2002.
(60) Provisional application No. 60/474,047, filed on May 29, 2003.
(60) Provisional application No. 60/474,837, filed on May 30, 2003.

(51) Int. Cl. G06F 17/60

(52) U.S. Cl. 705/37

(57) ABSTRACT

A new exchange-traded fund is provided. The method includes searching for publicly traded securities and a history of dividend yields associated with them, as well as an associated PE ratio. The securities are then sorted according to the amount of the associated dividend yields, and rated based on the dividend yields and, preferably, based also on their PE ratio. Several of the securities are then placed into the exchange-traded fund and shares in the exchange-traded fund are offered for sale. The fund can be traded in an e-commerce system through the Internet, within an intranet in a distributed system, or any of the conventional and traditional trading methods.

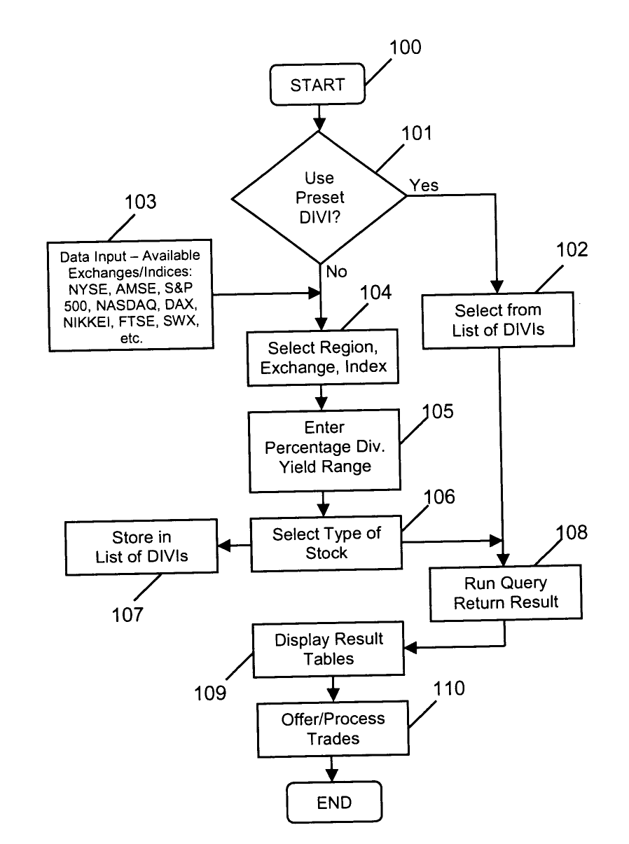

### CROSS-REFERENCE TO RELATED APPLICATION

This application claims the benefit under 35 U.S.C. §119(e) of my provisional application No. 60/409,648 filed Sep. 10, 2002, provisional application No. 60/474,047 filed May 29, 2003, and provisional application No. 60/474,837 filed May 30, 2003.

### BACKGROUND OF THE INVENTION

1. Field of the Invention

The invention lies in the financial and business method fields. More specifically, the invention relates to a novel type of exchange-traded fund (ETF) and to related computer and software products.

2. Description of the Related Art

Exchange-traded funds (ETFs) have recently become a popular trading vehicle for investors. These funds are similar to index mutual funds, i.e., mutual funds that are tied to respective indices, but they more closely resemble stocks. An exchange-traded fund is a collection of securities that may be traded on an exchange. Holding shares in an ETF represent ownership in an underlying portfolio of securities tracking a given stock exchange or other market index. Since the ETFs are not bought and sold through a fund company—they are traded through brokers or brokerage accounts—they can bought on margin and they can also be sold short, similar to regular stocks.

Some of the most popular ETFs include DIAMONDs (tracking the Dow Jones Industrial Average), FITRs (tracking fixed income treasuries), Spiders (tracking several Standard & Poors indices), and VIPERs (tracking several Vanguard index funds). These ETFs have become quite popular for a variety of reasons. For example, they can be traded throughout the trading hours on the exchanges—which is a perceived shortcoming of most mutual funds, which can only be traded after the close of the exchange. Also, the ETFs typically have very low trading overhead, i.e., very small account expenses as compared to the relatively high annual expenses of many of the mutual funds.

Neither the currently available exchange-traded funds nor any of the mutual funds or indices track dividend performance of any of the securities. Especially in light of the recent political climate, which appears to point towards the abolition or at least towards a reduction on income tax levied on dividend income, such a trading instrument would be desirable.

### SUMMARY OF THE INVENTION

It is accordingly an object of the invention to provide a method of defining an exchange-traded fund and a computer and software product for generating real-time fund information, which overcomes the above-mentioned disadvantages of the heretofore-known devices and methods of this general type and which further improves investor access to securities tied to dividend distributions.

With the foregoing and other objects in view there is provided, in accordance with the invention, a method of defining an exchange-traded fund, which comprises:

searching for publicly traded securities (e.g., stocks) and a history of dividend yields associated with the respective securities;

sorting the securities relative to an amount of the associated dividend yields, and rating the securities based on the associated dividend yields;

placing a plurality of the securities into the exchange-traded fund and weighting the individual securities within the exchange-traded fund in accordance with the associated dividend yields; and

offering for sale shares in the exchange-traded fund.

In accordance with an added feature of the invention, the searching step comprises also searching for a price-earnings ratio associated with the respective securities, and weighting the respective securities in the exchange-traded fund with the price-earnings ratio and the amount of the associated dividend yields. This provides for a better characterization of the stock. That is, if the last dividend distribution was very high, yet the price/earnings ratio is very high as well, the system may flag the security as questionable. If on the other hand, the dividend yield is high and the PE ratio is quite low, the security may be flagged with a much better rating.

In accordance with an additional feature of the invention, the novel method may be incorporated in a computer-readable medium having computer-executable instructions for performing the method. Similarly, there is advantageously provided and computer programmed to perform the novel method.

With the above and other objects in view there is also provided, in accordance with the invention, a virtual securities broker for assisting a customer in generating and purchasing a dividend-weighted fund instrument from a merchant, comprising:

a database containing customer information with identification and preferences related to the customer;

a client system for prompting the customer to select a predefined set of dividend-yielding securities or to input parameters for a new search defining a new set of dividend-yielding securities;

a server system programmed to search, via the Internet, a current state of the predefined set of dividend-yielding securities or within the parameters entered in the client system by the customer and to transmit a search result to the client system; and

a purchase processing system, connected to the server system and adapted to receive a purchase order from the customer via the client system, for the dividend-yielding securities and to fill the purchase order.

In accordance with a further feature of the invention, the server system is configured to search for stocks including a stock price and a history of dividend distributions, the client system is configured to display to the customer a percentage dividend yield defined by a percentage ratio of past dividend distribution over a given period of time relative to the price of the security.

In a preferred implementation, the invention belongs into an electronic commerce system having a computer system configured to search for securities, a history of dividend yields associated with the respective securities, and price-earnings ratios associated with the respective securities. In this context, I provide for a method of generating and offering for sale an exchange-traded fund. The method comprises:

upon receiving an initiation request from a customer, checking a database containing customer information with identification and preferences related to the customer;

prompting the customer to select a predefined set of dividend-yielding securities or to input parameters for a new search defining a new set of dividend-yielding securities;

searching for securities matching the parameters associated with the set of dividend-yielding securities, placing a plurality of the securities into the exchange-traded fund, weighting the individual securities within the exchange-traded fund in accordance with the associated dividend yields, and rating the securities based on an amount of the associated dividend yields; and

offering for sale shares in the exchange-traded fund.

In accordance with again an added feature of the invention, the system searches for a price-earnings ratio associated with the respective securities, and weights the respective securities in the exchange-traded fund with the price-earnings ratio and the amount of the associated dividend yields. As noted above, the interplay between the PE ratio and the dividend yield provides additional information concerning the stock, and thus adds a level of security to any resulting purchase order.

With the above and other objects in view there is also provided, in accordance with the invention, a method of placing an order in a securities-trading system having a server system connected in a network and a client system connected to the server system, which comprises:

under control of the client system, prompting a user for input selecting from available securities with a history of dividend distribution;

under control of the server system, searching the network for securities matching the user's search parameters and transmitting search results to the client system;

under control of the client system, displaying the search results to the user and prompting the user for further action, the further action including further input for a new search and placing a purchase order for a security or a collection of securities having a history of dividend distribution satisfying the user's search parameters.

In accordance with again an additional feature of the invention, the user is prompted for input where the user selects either a predefined set of dividend-yielding securities or a specific set of parameters for defining a new selection.

In accordance with a concomitant feature of the invention, the specific set of parameters includes a percentage yield defined by a percentage ratio of past dividend distribution over a given period of time relative to a price of the security (e.g., 12 months or any other time period).

Besides defining the novel security as an exchange traded fund, ETF, it may also be characterized as a novel financial “index.” In commercial settings I refer to my novel system as DIVIS™— Dividend Yielding Stocks. While the invention is explained herein with reference to the various United States exchanges and indices, such as the NYSE (New York Stock Exchange), AMSE (American Stock Exchange), S&P 500 (Standard & Poor 500) and NASDAQ (National Association of Securities Dealers Automated Quotation), it will be readily understood that other exchanges and indices are included as well. That is, a world index may utilize, by way of example, the Japanese Nikkei, the German DAX, the British FTSE, and the American NYSE. The system allows an investor to select any of the above exchanges or indices which have dividend yielding stocks. The collection is thus a novel exchange-traded funds with different dividend yields.

By way of example, an inventor can select a NYSE ETF with common stocks throwing off dividend yields of 2.5% to 10% or 2.5% to 7% or 2.5% and more meaning yields can go as high as the stocks listed on the NYSE or any of the other indices or AMEX exchange. The investor can select an ETF with common stocks throwing off stock dividend yields to meet the investor's risk comfort zone with different categories of dividend yields.

The primary advantage of the new exchange-traded fund resides in its adaptability to the investor's goals. For example, the institutional investor may tend to select an ETF composite—such as a composite of two exchanges such as the New York Stock Exchange and the American Stock Exchange and the two indices the S&P 500 and the NASDAQ—the combination forming an exchange traded fund with the best picks from several exchanges and indices. The query may be directed to stock dividend yields of 2.5% to 7% or 2.5% to 10% or 2.5% and more allowing the investor to select their risk comfort zone. The investor can also select two exchanges the NYSE and AMEX combined or two indices the S&P 500 and NASDAQ combined with the same selection of stock dividend yields throwing off the above percentage yielding dividend stocks. Changes and adaptations are very quick. The investor can quickly enter changes to his or her specialized ETFs to meet the investor's demands and comfort zones. When stocks on the above illustration of exchanges and indices fall in or out of percentage parameters they can be added to or deleted from the given ETF.

It will also be understood that investing in high-dividend yielding stocks is a desirable concept even when dividend yields are taxed. In light of the tax code changes proposed by the current administration, the dividend-yielding stocks have become even more desirable.

In accordance with a further feature of the invention, the ETFs proposed herein are not limited to a single-tier stock system, i.e, they are not only applicable to common stock, by they apply equally to preferred stock as well as all other classes and forms of stocks throwing off dividend yields. The primary and basic ETF, however, will be a common stock yielding dividend index. The financial dividend index includes all common stocks throwing off dividend yields from the NYSE, AMEX, S&P 500 and NASDAQ separately. The new dividend yielding stock exchange traded funds track the new dividend yielding stock index. Stocks that throw off dividend yields are quickly added to the ETF, and stocks that discontinue dividend yields can be quickly removed from the ETF. In that regard, the ETF resembles an index. A total composite index of the NYSE, AMEX, S&P 500 and NASDAQ can thus be made available and a composite of just the NYSE and AMEX combined exchanges can be made available, as well as a combined index of the S&P 500 and the NASDAQ indices.

Other features which are considered as characteristic for the invention are set forth in the appended claims.

Although the invention is illustrated and described herein as embodied in a method of defining an exchange-traded fund and a computer and software product for generating real-time fund information, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawing.

### BRIEF DESCRIPTION OF THE DRAWING

The FIGURE is a flowchart illustrating a sequence of interactions between a computer system and a user.

### DESCRIPTION OF THE PREFERRED EMBODIMENTS

Referring now to the sole FIGURE of the drawing in detail, there is illustrated a sequence of operations during which an ETF is defined and offered for purchase. Some of the individual steps may be predefined and the entire process may be automated. In some instances, several variables may be set by the user and the ETF thus created becomes a very adaptable security instrument.

Upon first starting the program at a step 100, the user may be queried at 101 whether he would like to use a preset Divi™ group. On answering yes, the system displays a list of preset queries at 102. The user then chooses a preset query from the list.

If the answer following the query 101 is in the negative, the system is initialized to provide all available and applicable security exchanges or indices from a database at 103. Then the user is prompted for a variety of input parameters starting at 104. For example, first the user may choose from a list of available exchanges and indices. In addition, the system provides a variety of combinations or the user may select individually until he or she requests that the system move to the next step. That is, in step 104, the user may select a single exchange or a single index, as well as any available combination.

In order to limit the search, the user will be prompted to enter a minimum percentage yield in step 105. Finally, the entry sequence will be terminated after the user has entered the type of stock to be considered at 106. That is, the system may be set to search only for common stock, or for a combination of common and preferred stock.

The program then branches to a step 107, where the results of the latest query sequence are stored in the database, to be displayed in the list of DIVIS™ the next time the user calls up step 102. At the same time, the program branches to step 108, where the query is processed. The results are then displayed in tabular form in step 109. From there, the user may choose individual stocks, or groups of stocks, for example by marking them and placing them into a virtual shopping cart at 110. The label “Offer/Process Trades” thus refers to a complete software vending and trading system—for instance with the now-conventional shopping cart and checkout verification layout, or with a one-click vending system.

### EXAMPLE 1

### New Dividend-Yielding Index

The first example provides specific keystrokes for a Bloomberg® equity quote query. The query will return items yielding 0.1% or more during the last 12 months, for securities trading on a United States composite of the New York Stock Exchange, the American Stock Exchange, the S&P 500 index, and the NASDAQ index:

a. Type ESRC <GO>

b. Type 21 (Popular Field Template) <GO>

c. TAB and type in the name COMPOSITE 0.1%+DIV <GO>

d. TAB to line number 2 and enter Min closing price of stocks <GO>

e. TAB to line number 7 and enter 0.1 for Min Dividend 12 Month Yield <GO>

f. Type 16 <GO> to filter countries, then 2 <GO> for North America, then 24 <GO> for U.S., and MENU to go back to main search screen

g. Type 17 <GO> to filter exchanges, then 2 <GO> for North America, then 24 <GO> for U.S., then 12 for American and 20 for New York. Hit MENU twice to go back to main search screen

h. Type 18 <GO> to filter indices, then 2 <GO> for North/Latin America, then 25 <GO> for NASDAQ Composite Index, then PAGE FWD once, and type then 17 <GO> for S&P 500 Index.

i. Hit MENU to go back to main search screen Type 21 <GO> to filter security types, then 1 <GO> for Common/Ordinary, and MENU to go back to main search screen

j. Type 1 <GO> to run search, then choose 1 <GO> for display results and then type 1 <GO> to output results.

k. On each subsequent day, type ESRC <GO> and then Select Saved Search by typing number the corresponding search for the COMPOSITE 0.1%+DIV search. Then type 21 <GO> to run search again.

Running the search on subsequent days will add or delete securities that fit the criteria set in the search.

An exemplary output display would contain the necessary information, namely the ticker symbol, the extent of the search (here the two US exchanges and two US indices), the name of the security, the last-quoted price, P/E ratio, and the dividend yield, in percent of the stock price, over a period of the last 12 months.

| | Exchange | | | | Dividend |
|---|---|---|---|---|---|
| Ticker | Code | Short Name | Price | P/E | yield (%) |
| RGC | US | REGAL ENTERT AI-A | 18.95 | 17.50 | 28.32 |
| NL | US | NL INDUSTRIES | 17.70 | 30.00 | 18.64 |
| ANH | US | ANWORTH | 16.39 | 8.58 | 11.59 |
| | | MORTGAGE | | | |
| RJR | US | RJ REYNOLDS TOB | 35.59 | 8.81 | 10.68 |
| VGR | US | VECTOR GROUP LTD | 15.11 | NA | 10.48 |
| TE | US | TECO ENERGY INC | 12.14 | 7.14 | 8.98 |
| ALD | US | ALLIED CAP CORP | 26.60 | 15.83 | 8.61 |
| UIL | US | UIL HLDGS CORP | 36.27 | 14.86 | 7.94 |
| IDA | US | IDACORP INC | 24.32 | 24.57 | 7.65 |
| MMA | US | MUNI MTG & EQTY | 24.11 | 16.29 | 7.36 |
| RGR | US | STURM RUGER 8, CO | 11.10 | 35.81 | 7.21 |
| GNI | US | GREAT NORTHN IRN | 83.40 | 13.18 | 7.19 |
| DQE | US | DGE INC | 15.23 | 12.68 | 8.57 |
| AEP | US | AMERICAN ELECTRI | 29.31 | 10.47 | 6.48 |
| LYO | US | LYONDELL CHEMICA | 14.11 | NA | 6.38 |
| DUK | US | DUKE ENERGY CORP | 17.60 | 11.28 | 6.25 |
| KSL | US | KANEB SERVICES | 27.30 | 13.93 | 6.23 |
| EK | US | EASTMAN KODAK | 29.30 | 11.96 | 6.14 |

### EXAMPLE 2

### New Dividend-Yielding Index

This example provides a Bloomberg® key stroke sequence that returns equities yielding at least 0.1% for the last 12 months that trade on the New York Stock Exchange.

a. Type ESRC <GO>

b. Type 21 (Popular Field Template) <GO>

c. TAB and type in the name NYSE 0.1%+DIV <GO>

d. TAB to line number 2 and enter Min closing price of stocks <GO>

e. TAB to line number 7 and enter 0.1 for Min Dividend 12 Month Yield <GO>

f. Type 16 <GO> to filter countries, then 2 <GO> for North America, and then 24 <GO> for U.S. Hit MENU to go back to main search screen

g. Type 17 <GO> to filter exchanges, then 2 <GO> for North America, then 24 <GO> for U.S., and then 20 for New York. Hit MENU twice to go back to main search screen

h. Type 21 <GO> to filter security types, and then 1 <GO> for Common/Ordinary. Hit MENU to go back to main search screen

i. Type 1 <GO> to run search, then choose 1 <GO> for display results and then type 1 <GO> to output results.

j. On each subsequent day, type ESRC <GO> and then Select Saved Search by typing number the corresponding search for the NYSE 0.1%+DIV search. Then type 21 <GO> to run search again.

The last step adds or deletes securities that fit the criteria set in the search.

### EXAMPLE 3

### New Dividend-Yielding Index

In order to perform the same search with reference to equities trading on the American Stock Exchange, it is only necessary to modify the third line. That is, instead of entering “NYSE 0.1%+DIV”, the proper line is “AMEX 0.1%+DIV,” and a further change is effected in step g.

### EXAMPLE 4

### New Dividend-Yielding Index

In a further variation, the same search may be performed with reference to equities trading within the S&P 500 index. Here, therefore, the third line (AMEX 0.1%+DIV) is be replaced by “S&P 500 0.1%+DIV” and step g is adapted accordingly.

### EXAMPLE 5

### New Dividend-Yielding Index

Further variations should now be readily understood. For example, the same search may be performed with reference to equities trading within the NASDAQ index. Here, therefore, the third line (S&P 500 0.1%+DIV) is be replaced by “NASDAQ 0.1%+DIV.” A further adjustment will be made in step g.

### EXAMPLE 6

### New Exchange-Traded Fund

The following sequence of keystrokes, again on the Bloomberg® system, will provide equities yielding at least 2½% or more for the last 12 months. The search is limited to the New York Stock Exchange:

a. Type ESRC <GO>

b. Type 21 (Popular Field Template) <GO>

c. TAB and type in the name NYSE 2½+DIV <GO>

d. TAB to line number 2 and enter Min closing price of stocks <GO>

e. TAB to line number 7 and enter 2.5 for Min Dividend 12 Month Yield <GO>

f. Type 16 <GO> to filter countries, then 2 <GO> for North America, then 24 <GO> for U.S. Hit MENU to go back to main search screen

g. Type 17 <GO> to filter exchanges, then 2 <GO> for North America, then 24 <GO> for U.S., and then 20 for New York. Hit MENU twice to go back to main search screen

h. Type 21 <GO> to filter security types, then 1 <GO> for Common/Ordinary, and MENU to go back to main search screen

i. Type 1 <GO> to run search, then choose 1 <GO> for display results and then type 1 <GO> to output results.

j. On each subsequent day, type ESRC <GO> and then Select Saved Search by typing number the corresponding search for NYSE 2½% DIV search. Then type 21 <GO> to run search again.

Those of skill in the art will know how to adapt this search for any of the other available exchanges, for different regions, for different securities, for longer or shorter time periods, and for higher or lower dividend percentage yields.

For example, an exchange-traded fund that was set to S&P 500, 2.5% to 10%, 12-month dividend history, on Sep. 5, 2003 provided the following results:

S&P500 2½-10%, 106 Securities Found

| | | | Closing | | Div. |
|---|---|---|---|---|---|
| | Ex- | | Price | | 12 Mo. |
| | change | | Previous | | Yld |
| Ticker | Code | Short Name | Day | P/E | Gross |
| TE | SP | TECO ENERGY INC | 12.14 | 7.14 | 8.98 |
| AEP | SP | AMERICAN ELECTRI | 29.31 | 10.47 | 6.48 |
| DUK | SP | DUKE ENERGY CORP | 17.60 | 11.28 | 6.25 |
| EK | SP | EASTMAN KODAK | 29.30 | 11.96 | 6.14 |
| MO | SP | ALTFIA GROUP INC | 41.78 | 9.24 | 6.13 |
| NI | SP | NISOURCE INC | 19.46 | 11.45 | 5.96 |
| AEE | SP | AMEREN CORP | 43.06 | 14.31 | 5.90 |
| DTE | SP | DTE ENERGY CO | 35.69 | 11.86 | 5.77 |
| UST | SP | UST INC | 34.71 | 11.73 | 5.65 |
| ED | SP | CONS EDISON INC | 39.76 | 13.71 | 5.62 |
| SBC | SP | SBC COMMUNICATIO | 23.12 | 11.74 | 5.43 |
| PGN | SP | PROGRESS ENERGY | 41.62 | 11.37 | 5.35 |
| TUP | SP | TUPPERWARE CORP | 16.56 | 18.00 | 5.31 |
| GAS | SP | NICOR INC | 35.06 | 12.05 | 5.28 |
| PCL | SP | PLUM CREEK TIMBR | 26.56 | 21.95 | 5.27 |
| CIN | SP | CINERGY CORP | 35.35 | 12.49 | 5.18 |
| KSE | SP | KEYS PAN CORP | 34.55 | 14.10 | 5.15 |
| PGL | SP | PEOPLES ENERGY | 41.42 | 14.23 | 5.07 |

The novel ETF system provided herein lends itself to a modification which may be referred to as Dividend Stock Options (commercially: Divi-Opts™).

Some exchange traded funds also have options. One example of a very popular exchange traded fund is the above-mentioned Diamonds. Diamonds track the DOW JONES 30 stocks. Exchange traded funds are tracking stocks in an index. When an investor buys one share of a Diamond he owns a small piece of all the DOW 30 stocks. The investor can buy the one share like a stock or and sell it like a stock and it has similar trading aspects like a stock. The investor can also buy a Diamond options with puts, calls & strike prices which track the DOW 30 stocks.

The dividend stock options are similar in nature. They track all of the dividends yielding stock exchanges and indices as illustrated above. For example-investors can buy put and call dividends stock options for the NYSE, AMEX, S&P 500 or NASDAQ. Investor's can also buy a composite of the above in an option or buy an option for just the NYSE and AMEX combined only or just the S&P 500 and NASDAQ combined for an option investment. Similar to traditional option investing, the investor typically selects a strike price in or out of the money with usually a 30 to 60 to 90 day time value. The novel system may be set up to offer purchasing options at the index price and offering time values with 6 month or 12 month or 18 month periods to make option buying less complicated with more time value. Options can track common stock performance as well as preferred or any other class or form of stock.

It follows quite clearly from the foregoing description that the invention disclosed herein is primarily applicable to software processing, whether it be in a distributed system or a self-contained, autonomous system. The primary implementation thus has to do with machines and methods for performing data processing and calculation operations, as well as the processing of financial data. The term “client system” here pertains to a user platform including, at a minimum, a display unit for displaying prompts and information to the customer as well as an input unit allowing the customer to respond to various prompts. The term “server system” pertains to a networked system, a database with the necessary data, and also to a system that is enabled to process trades for the new dividend-weighted exchange-traded fund.

Distribution of the novel process is best effected via computer-readable media. Such media include all kinds of computer memory devices such as floppy disks, high-density disks, hard disk drives, CDs, DVDs, Flash-ROM, non-volatile ROM, RAM, EEPROM (memory cards, memory sticks, etc.) and carrier waves for the transmission of data through wired and wireless systems.

I claim:

1. A method of defining an exchange-traded fund, which comprises:
searching for publicly traded securities and a history of dividend yields associated with the respective securities;
sorting the securities relative to an amount of the associated dividend yields, and rating the securities based on the associated dividend yields;
placing a plurality of the securities into the exchange-traded fund and weighting the individual securities within the exchange-traded fund in accordance with the associated dividend yields; and
offering for sale shares in the exchange-traded fund.

2. The method according to claim 1, wherein the searching step comprises also searching for a price-earnings ratio associated with the respective securities, and weighting the respective securities in the exchange-traded fund with the price-earnings ratio and the amount of the associated dividend yields.

3. A computer-readable medium having computer-executable instructions for performing the method according to claim 1.

4. A computer programmed to perform the method according to claim 1.

5. A virtual securities broker for assisting a customer in generating and purchasing a dividend-weighted fund instrument from a merchant, comprising:
a database containing customer information with identification and preferences related to the customer;
a client system for prompting the customer to select a predefined set of dividend-yielding securities or to input parameters for a new search defining a new set of dividend-yielding securities;
a server system programmed to search, via the Internet, a current state of the predefined set of dividend-yielding securities or within the parameters entered in said client system by the customer and to transmit a search result to said client system; and
a purchase processing system, connected to said server system and adapted to receive a purchase order from the customer via said client system, for the dividend-yielding securities and to fill the purchase order.

6. The virtual securities broker according to claim 5, wherein said server system is configured to search for stocks including a stock price and a history of dividend distributions, said client system is configured to display to the customer a percentage dividend yield defined by a percentage ratio of past dividend distribution over a given period of time relative to the price of the security.

7. A computer-readable medium having computer-executable instructions for implementing the virtual securities broker according to claim 4.

8. In an electronic commerce system having a computer system configured to search for securities, a history of dividend yields associated with the respective securities, and price-earnings ratios associated with the respective securities, a method of generating and offering for sale an exchange-traded fund, which comprises:
upon receiving an initiation request from a customer, checking a database containing customer information with identification and preferences related to the customer;
prompting the customer to select a predefined set of dividend-yielding securities or to input parameters for a new search defining a new set of dividend-yielding securities;
searching for securities matching the parameters associated with the set of dividend-yielding securities, placing a plurality of the securities into the exchange-traded fund, weighting the individual securities within the exchange-traded fund in accordance with the associated dividend yields, and rating the securities based on an amount of the associated dividend yields; and
offering for sale shares in the exchange-traded fund.

9. The method according to claim 8, wherein the searching step comprises also searching for a price-earnings ratio associated with the respective securities, and weighting the respective securities in the exchange-traded fund with the price-earnings ratio and the amount of the associated dividend yields.

10. A method of placing an order in a securities-trading system having a server system connected in a network and a client system connected to the server system, which comprises:
under control of the client system, prompting a user for input selecting from available securities with a history of dividend distribution;
under control of the server system, searching the network for securities matching the user's search parameters and transmitting search results to the client system;
under control of the client system, displaying the search results to the user and prompting the user for further action, the further action including further input for a new search and placing a purchase order for a security or a collection of securities having a history of dividend distribution satisfying the user's search parameters.

11. The method according to claim 10, which comprises prompting the user for input selecting either a predefined selection of dividend-yielding securities or a specific set of parameters for defining a new selection.

12. The method according to claim 10, wherein the specific set of parameters includes a percentage yield defined by a percentage ratio of past dividend distribution over a given period of time relative to a price of the security.

13. A computer system interconnected and programmed to perform the method according to claim 10.

14. A computer-readable medium having computer-executable instructions for implementing the method according to claim 10.
